(19) United States
(12) Patent Application Publication
(10) Pub. No.: US 2007/0285515 A1
(43) Pub. Date: Dec. 13, 2007

(54) METHOD AND APPARATUS FOR CALIBRATING VIDEO SIGNALS

(76) Inventors: MARK HUNTER, Cary, NC (US); Brian Levey, Yardley, PA (US)

Correspondence Address: Patterson & Sheridan, LLP, Suite 100, 595 Shrewsbury Avenue, Shrewsbury, NJ, 07702, US

(21) Appl. No.: 11/760,563

(22) Filed: Jun. 8, 2007

Related U.S. Application Data
(60) Provisional application No. 60/812,553, filed on Jun. 9, 2006.

(51) Int. Cl. H04N 17/02

(52) U.S. Cl. 348/189

(57) ABSTRACT

In one embodiment, the present invention is a method and apparatus for calibrating video signals. One embodiment of a method for calibrating chrominance/luminance of a video signal for display on a display device includes receiving an uncalibrated video signal from a video source, calculating a correction necessary to calibrate the color of the uncalibrated video signal, using stored correction data, and applying the correction to produce a calibrated video signal in substantially real time.

### CROSS REFERENCE TO RELATED APPLICATIONS

This application claims the benefit of U.S. Provisional Patent Application Ser. No. 60/812,553, filed Jun. 9, 2006, which is herein incorporated by reference in its entirety.

### BACKGROUND OF THE DISCLOSURE

The invention relates generally to the calibration of video signals, and relates more specifically to correcting the chrominance and luminance of video signals for display.

### SUMMARY OF THE INVENTION

In one embodiment, the present invention is a method and apparatus for calibrating video signals. One embodiment of a method for calibrating the chrominance and/or luminance of a video signal for display on a display device includes receiving an uncalibrated video signal from a video source, calculating a correction necessary to calibrate the chrominance and/or luminance of the uncalibrated video signal, storing and using stored calculated correction data, and applying the correction to produce a calibrated video signal in substantially real time.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of the present invention in use;

FIG. 2 is a block diagram illustrating one embodiment of a hardware architecture for the calibration device of FIG. 1;

FIG. 3 is a block diagram illustrating one embodiment of the video processing field programmable gate array of FIG. 2, according to the present invention; and

FIG. 4 is a flow diagram illustrating one embodiment of a method for calibrating an input video signal, according to the present invention.

To facilitate understanding, identical reference numerals have been used, where possible, to designate identical elements that are common to the figures.

### DETAILED DESCRIPTION

In one embodiment, the present invention is a stand-alone device that calibrates a video signal (i.e., a series of video images) in substantially real time (i.e., as the video signal is received). One embodiment of the present invention is a device that corrects the chrominance and luminance of the video signal before sending the video signal on to a display device (e.g., a television, a computer monitor or the like). The device stores calibration coefficients that enable the device to improve the image going to the display. In one embodiment, the calibration coefficients are determined using a Spyder colorimeter, commercially available from Datacolor of Lawrenceville, N.J. The present invention externalizes the calibration of the video signal and corrects the image on any display device, on the fly, without relying on the display device manufacturer to expose adjustments, or even relying on the user to find the adjustments and set them correctly.

The present invention allows a user to calibrate any input that he/she chooses without having to personally generate test patterns for the format he/she is calibrating (e.g., high-definition television). The user can calibrate as many, or as few, of the inputs on the display device as he/she chooses by simply pressing a button.

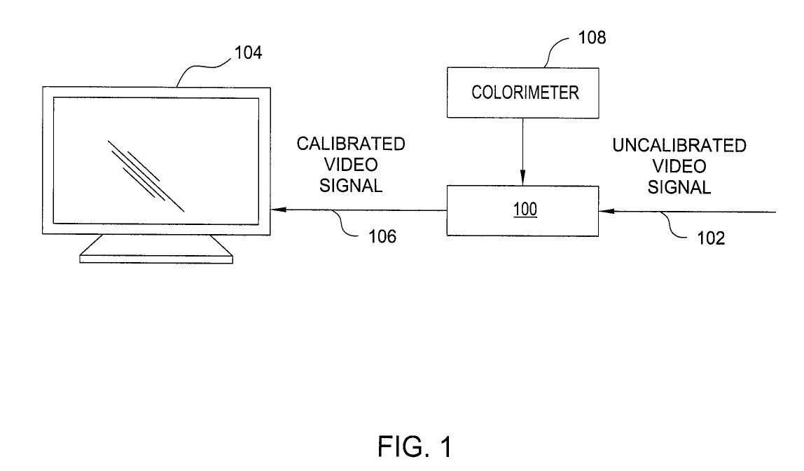

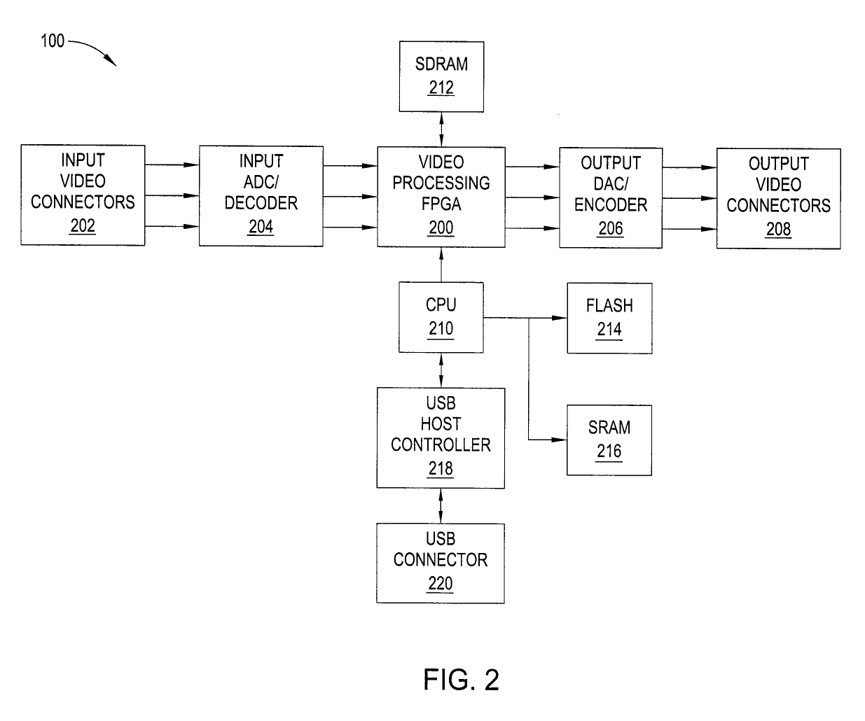

FIG. 1 is a schematic diagram illustrating one embodiment of the present invention in use. As discussed above, the present invention is a stand-alone calibration device 100 that operates in conjunction with a calorimeter 108 to calibrate a video signal for display on a display device 104. Specifically, the calibration device 100 receives the uncalibrated video signal 102 and measurements of color of the display device's display from the calorimeter 108. As discussed in further detail with respect to FIGS. 2-4, the calibration device 100 uses this information to produce a calibrated video signal 106 that the calibration device 100 provides to the display device 104, thereby improving the quality of the images displayed on the display device 104.

FIG. 2 is a block diagram illustrating one embodiment of a hardware architecture for the calibration device 100 of FIG. 1. As illustrated, one embodiment of the calibration device 100 comprises a central processing unit (CPU) 210, memory (e.g., synchronous dynamic random access memory (SDRAM) 212, static random access memory (SRAM) 216, Flash memory 214, or the like), a video processing field programmable gate array (FPGA) 200, and various input/output (I/O) devices, including one or more input video connectors 202, an input analog-to-digital (ADC) decoder 204 (if necessary), one or more output video connectors 208, an output digital-to-analog converter 206 (if necessary), a universal serial bus (USB) host controller 218, and a USB connector 220.

The video processing FPGA 200 can be represented by one or more software applications (or even a combination of software and hardware, e.g., using application specific integrated circuits (ASIC)), where the software is operated by the CPU 210 in the memory (e.g., Flash memory 214 or SRAM 216) of the calibration device 100.

The input video connectors 202 are adapted to connect to the source of the uncalibrated video signal and receive the uncalibrated video signal therefrom. The uncalibrated video signal is then provided to the input ADC/decoder 204 for analog-to-digital conversion (if the video signal is not already in a usable digital form) before being provided to the video processing FPGA 200 for further processing.

The video processing FPGA 200 performs video data correction on the input, uncalibrated video signal and controls the output of the calibrated video signal to the output DAC/encoder 206. The video processing FPGA 200 is further coupled to the CPU 210 and to memory (e.g., SDRAM 212). As discussed in further detail below, the memory coupled to the video processing FPGA 200 (e.g., SDRAM 212) is used to store bitmaps of incoming images in the video signal and look-up tables (LUT's) for caption letters.

The output video connectors 208 are adapted to connect to the display of the display device. The output video connectors 208 receive the calibrated video signal from the output DAC/encoder 206 and provide the calibrated video signal to the display.

The USB connector 220 is adapted to connect to a calorimeter (e.g., colorimeter 108 of FIG. 1) that provides measurements of the chrominance and/or luminance of the display of the display device. As discussed in further detail below, this data is used to determine the extent to which an uncalibrated video signal must be corrected. The USB connector 220 is further connected to the USB host controller 218, which provides the measurements directly to the CPU 210.

In one embodiment, the number and type (e.g., component video, separate video (S-video), high-definition multimedia interface (HDMI), digital video interface (DVI) or the like) of outputs are the same as the number and type of inputs (i.e., the calibration device 100 does not perform conversion in the illustrated embodiment). Although both the input video connectors 202 and the output video connectors 208 are illustrated in FIG. 2 as having three connections (i.e., three inputs and three outputs), embodiments of the present invention may accommodate any number of inputs and outputs.

If the calibration device 100 is not in operating mode (e.g., is turned off), the output video connectors 208 simply pass the unchanged (i.e., uncalibrated) video signal to the display.

In order to adapt the calibration device 100 for processing of multiple video sources, additional components may be incorporated in the calibration device 100, including additional input and output ports, input and output switching capabilities, format/resolution tracking for each input/output, look-up table storage for each input/output, calibration status tracking for each input/output, a receiver (e.g., an infrared (IR) receiver) to handle control, and remote control (e.g., an IR remote control) for controlling the calibration device and ASIC modification to support logic and flow. Alternatively, multiple single-purpose calibration devices 100 (i.e., each supporting only one input/output type) may be implemented (e.g., “stacked”) to support processing for multiple video sources.

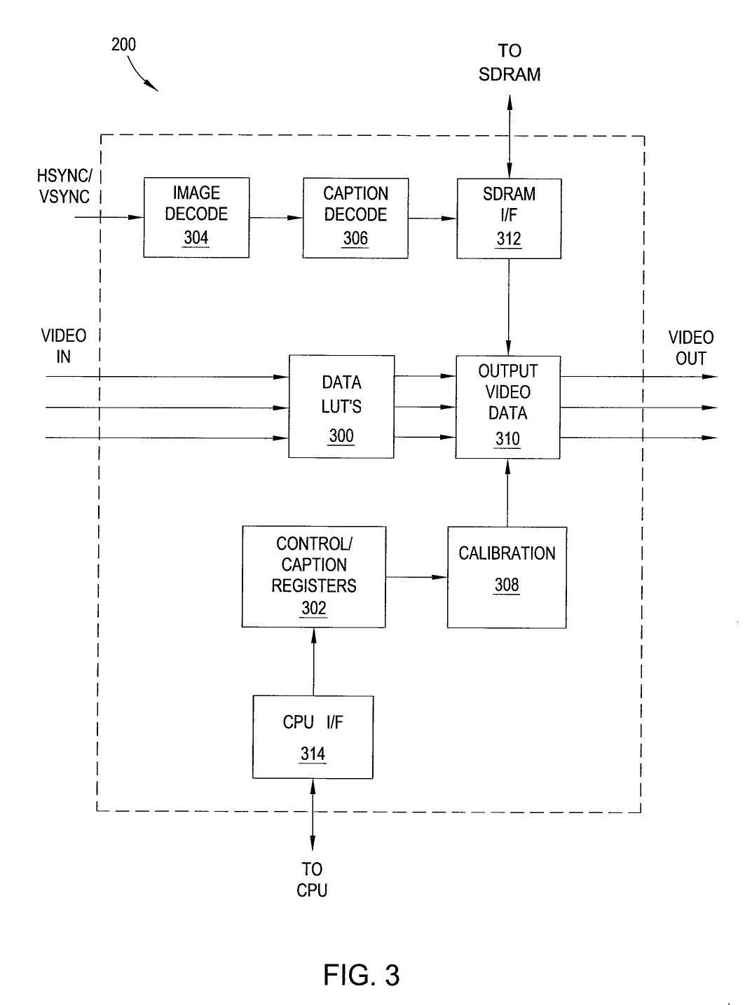

FIG. 3 is a block diagram illustrating one embodiment of the video processing FPGA 200 of FIG. 2, according to the present invention. As illustrated, the video processing FPGA 200 comprises data look-up tables (LUT's) 300, control/caption registers 302, an image decode module 304, a caption decode module 306, a calibration module 308, an output video data module 310 and various interfaces to other components of the calibration device 100 (e.g., an SDRAM interface 312, a CPU interface 314 and the like).

The LUT's 300 store correction data for the incoming video channels. Specifically, the LUT's 300 map each input color in an uncalibrated video signal to an output (calibrated) color. In one embodiment, the LUT's 300 are simplified video cards with LUT table memory.

The control/caption registers 302 are internal registers that store information including data control, setup, transfer type, and calibration. In one embodiment, 128 registers, each of which is five bits deep, are used to store the necessary captioning information during calibration of a video signal.

The calibration module comprises state machines and logic that control calibration routines. The image decode module 304 comprises state machines and logic that control image sizing requirements for other components of the video processing FPGA 200. The caption decode module 306 comprises state machines, logic and registers that control the captioning during calibration.

The output video data module 310 comprises a video data multiplexer. The output video data module 310 provides video signals to the output DAC and/or encoder 206 of the calibration device 100. When the calibration device 100 is in operating mode, the output video data module 310 provides a calibrated video signal. In other modes, the output video data module 310 may provide an uncalibrated signal, a split screen signal, or a calibration signal.

The interfaces include an SDRAM peripheral interface 312 to the SDRAM 212 of the calibration device 100 and a CPU peripheral interface 314 to the CPU 210 of the calibration device 100. In one embodiment, one or both of the interfaces 312 and 314 is an eight-bit data interface. In another embodiment, one or both of the interfaces 312 and 314 is a sixteen-bit data interface.

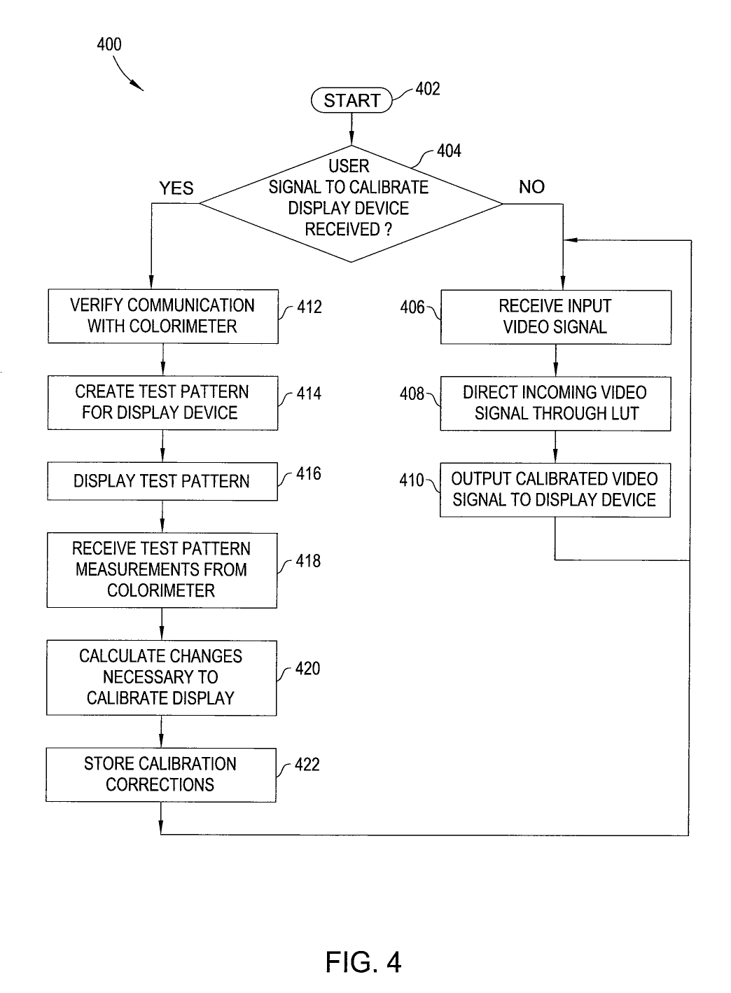

FIG. 4 is a flow diagram illustrating one embodiment of a method 400 for calibrating an input video signal, according to the present invention. The method 400 may be implemented, for example, in a calibration device such as the calibration device 100 described above.

The method 400 is initialized at step 402 and proceeds to step 404, the method 400 determines whether a user signal requesting calibration of the display device has been received. In one embodiment, the user signal is received via the press of a button (e.g., on the external housing of the calibration device). In another embodiment, the user signal is received via the placement of the calibration device in the path of a video signal from a source to the display device (i.e., “connecting” the calibration device to the video source, the display device and a power supply).

If the method 400 concludes in step 404 that a user signal has not been received, the method 400 proceeds to step 406, where the method 400 receives an input (uncalibrated) video signal from the video source.

In step 408, the method 400 passes the input video signal through a LUT. That is, the method 400 calibrates the input video signal using the corrections stored in the LUT. The method 400 then outputs the calibrated video signal to the display device in step 410 before returning to step 406 and proceeding as described above to receive and calibrate the incoming video signal.

Referring back to step 404, if the method 400 concludes that a user signal requesting calibration of the display device has been received, the method 400 proceeds to step 412 and verifies communication with a calorimeter that is deployed to measure the color of the display.

The method 400 then proceeds to step 414 and creates a test pattern for display on the display device. In one embodiment, the test pattern is generated internally by the video processing FPGA, and any incoming video data stream is effectively ignored while the method 400 outputs its own internally generated video stream for presentation to the display device. In another embodiment, the test pattern is generated by writing coefficients to the LUTs in order to effectively overwrite the incoming video data stream and output any arbitrary test pattern that the application may require. The method 400 displays the test pattern on the display device in step 416.

In step 418, the method 400 receives measurements of the displayed test pattern from the calorimeter. The method 400 then proceeds to step 420 and calculates the corrections that are required to calibrate the chrominance and/or luminance displayed on the display device, in accordance with the measurements received from the calorimeter. The calculated corrections are stored in the LUT in step 422, before the method 400 advances to step 406 and proceeds as described above to receive and calibrate the incoming video signal using the newly calculated corrections.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for calibrating at least one of the chrominance and the luminance of a video signal for display on a display device, the method comprising:
receiving an uncalibrated video signal from a video source;
calculating a correction necessary to calibrate the color of the uncalibrated video signal, using stored correction data; and
applying the correction to produce a calibrated video signal.

2. The method of claim 2, further comprising:
providing the calibrated video signal to the display device.

3. The method of claim 1, wherein the calculating comprises:
mapping a color of the uncalibrated video signal to a calibrated color.

4. The method of claim 3, wherein the mapping comprises:
displaying a test pattern on the display device;
receiving measurements of the color on the display device;
determining the changes necessary to calibrate the color; and
storing the necessary changes as the stored correction data.

5. The method of claim 4, wherein the measurements are received from a colorimeter.

6. The method of claim 4, wherein the test pattern is generated without regard for the video source.

7. The method of claim 4, wherein the stored correction data is stored in one or more lookup tables.

8. The method of claim 1, wherein the correction corrects the chrominance and luminance of the uncalibrated video signal.

9. The method of claim 1, wherein the applying is performed in substantially real time as the uncalibrated video signal is received.

10. A computer readable medium containing an executable program for calibrating at least one of the chrominance and the luminance of a video signal for display on a display device, where the program performs the steps of:
receiving an uncalibrated video signal from a video source;
calculating a correction necessary to calibrate the color of the uncalibrated video signal, using stored correction data; and
applying the correction to produce a calibrated video signal.

11. Apparatus for calibrating at least one of the chrominance and the luminance of a video signal for display on a display device, the apparatus comprising:
at least one input video connector for receiving an uncalibrated video signal from a video source;
a video processing field programmable gate array for calculating a correction necessary to calibrate the at least one of the chrominance and the luminance of the uncalibrated video signal, using stored correction data, the video processing field programmable gate array being further configured for applying the correction to produce a calibrated video signal.

12. The apparatus of claim 11, further comprising:
at least one output video connector for providing the calibrated video signal to the display device.

13. The apparatus of claim 12, wherein a number of input video connectors equals a number of output video connectors, and a type of input video connector matches a type of output video connector.

14. The apparatus of claim 12, wherein at least one of the at least one input video connector and the at least one output video connector is configured to support one or more of: component video, separate video (s-video), high-definition multimedia interface (HDMI) or a digital video interface (DVI).

15. The apparatus of claim 11, wherein the video processing field programmable gate array comprises:
a lookup table mapping a color of the uncalibrated video signal to a calibrated color.

16. The apparatus of claim 15, wherein the video processing field programmable gate array further comprises:
means for displaying a test pattern on the display device;
means for receiving measurements of the color on the display device;
means for determining the changes necessary to calibrate the color; and
means for storing the necessary changes as the stored correction data.

17. The apparatus of claim 16, further comprising:
means for generating the displayed test pattern.

18. The apparatus of claim 16, further comprising a universal serial bus connector for connecting the apparatus to a colorimeter.

19. The apparatus of claim 11, wherein the correction corrects the chrominance and luminance of the uncalibrated video signal.

20. The apparatus of claim 11, wherein the video processing field programmable gate array applies the correction in substantially real time as the uncalibrated video signal is received.
